(19) United States
(12) Patent Application Publication
(10) Pub. No.: US 2013/0233494 A1
(43) Pub. Date: Sep. 12, 2013

(54) COMPONENT ADHESIVE BONDING STRUCTURE AND COMPONENT SEPARATION METHOD

(71) Applicant: FUJITSU LIMITED, Kawasaki-shi (JP)

(72) Inventors: Yutaka NODA, Kawasaki (JP); Naoki Ishikawa, Nagano (JP); Masayuki Kitajima, Yokohama (JP)

(73) Assignee: FUJITSU LIMITED, Kawasaki-shi (JP)

(21) Appl. No.: 13/775,311

(22) Filed: Feb. 25, 2013

(30) Foreign Application Priority Data
Mar. 12, 2012 (JP) 2012-055043

(51) Int. Cl. B32B 7/06; B32B 43/00

(52) U.S. Cl. CPC B32B 7/06; B32B 43/006
USPC 156/711; 428/343

(57) ABSTRACT

A configuration includes the adhesive member to adhesively bond components together and a thermo-expandable material to expand upon being heated in the way of being disposed between at least one of the components adhesively bonded together by the adhesive member and the adhesive member and to push the adhesive member in a direction of getting apart from at least one of the components.

### CROSS-REFERENCE TO RELATED APPLICATION

This application is based upon and claims the benefit of priority of the prior Japanese Patent Application No. 2012-055043, filed on Mar. 12, 2012, the entire contents of which are incorporated herein by reference.

### FIELD

The present disclosure relates to a component adhesive bonding structure and a component separation method.

### BACKGROUND

Over the recent years, such technologies have been contrived as to facilitate separating from each other objects adhesively bonded together by a bonding agent or an adhesive agent (refer to, e.g., Patent documents 1-4).

### [Patent Document]

[Patent document 1] International Publication Pamphlet No. WO2007/122728

[Patent document 2] Japanese Laid-open Patent Publication No. 2010-260880

[Patent document 3] Japanese Utility Model Application Laid-Open Publication No.H05-46936

[Patent document 4] Japanese Laid-open Patent Publication No. 2008-94957

### SUMMARY

The present application discloses a component adhesive bonding structure which follows.

A component adhesive bonding structure including:

an adhesive member to adhesively bond components together; and

a thermo-expandable material to expand upon being heated in the way of being disposed between at least one of the components being adhesively bonded together by the adhesive member and the adhesive member.

Further, the present application discloses a component separation method which follows.

A component separation method including:

heating and thus expanding a thermo-expandable material being disposed between at least one of components being adhesively bonded by an adhesive member via which to adhesively bond the components together and the adhesive member; and

pushing the adhesive member in such a direction as to get apart from at least one of the components.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a view of a component adhesive bonding structure according to an embodiment;

FIG. 2 is a view depicting one example of a component separation method according to the embodiment;

FIG. 3 is a view of the component adhesive bonding structure according to a modified example of the embodiment;

FIG. 4 is a view of the component separation method according to a modified example of the embodiment;

FIG. 5 is a view illustrating applied examples of the embodiment and the modified example;

FIG. 6 is a view of one example of a recessed groove disposed in a whole circumference along an edge of an opening; and

FIG. 7 is a view of one example of the recessed groove disposed in a part of the edge of the opening.

### DESCRIPTION OF EMBODIMENTS

An embodiment of the disclosure of the present application will hereinafter be described. The embodiment, which will hereinafter be discussed, is an exemplification of one mode of the disclosure of the present application, and the technical scope of the disclosure of the present application is not limited to the following mode of the disclosure.

### Embodiment

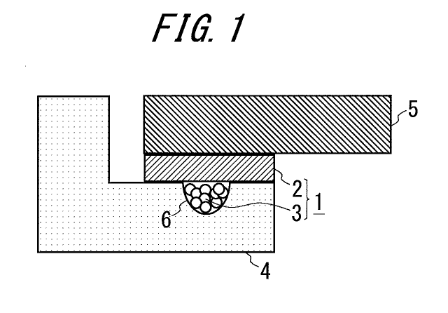

FIG. 1 illustrates a component adhesive bonding structure according to an embodiment. A component adhesive bonding structure 1 according to the embodiment includes an adhesive member 2 and a thermo-expandable material 3. The adhesive member 2 adhesively bonds a first component 4 and a second component 5 together. The thermo-expandable material 3 is put into a recessed portion 6 formed in a part of an adhesive surface of the first component 4 as well as the part between the first component 4 and the adhesive member 2.

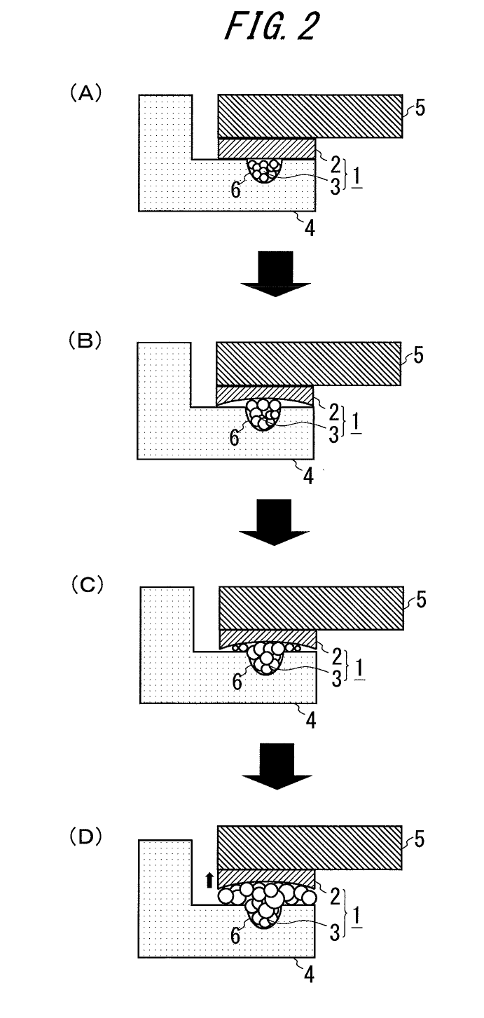

The first component 4 and the second component 5, which have been adhesively bonded together by the component adhesive bonding structure 1 described above, can be separated in a manner given below. FIG. 2 illustrates one example of a component separation method according to the embodiment.

The thermo-expandable material 3 expands when heated. The thermo-expandable material 3, when expanding due to the heating, pushes at least a portion, adjacent to the thermo-expandable material 3, of the adhesive member 2.

The adhesive member 2, if a pushing force of the thermo-expandable material 3 exceeds adhesive force of the adhesive member 2, starts being peeled off from the first component 4 with its starting point being a portion where the thermo-expandable material 3 is disposed (see FIG. 2(B)). The adhesive member 2 is further peeled off from the first component 4 as the expansion of the thermo-expandable material 3 advances (see FIG. 2(C)). The adhesive member 2 is, when the expansion of the thermo-expandable material 3 further advances, exfoliated from the first component 4.

The second component 5 is, upon the adhesive member 2 being exfoliated from the first component 4, pushed apart from the first component 4 by dint of the pushing force of the thermo-expandable material 3 (see FIG. 2(D)).

The component adhesive bonding structure 1 is configured so that the thermo-expandable material 3, which is extruded from the recessed portion 6 when the thermo-expandable material 3 is heated, pushes the adhesive member 2 in such a direction as to get apart from the first component 4, whereby the components are separated from each other. Hence, the component adhesive bonding structure 1 has a less possibility of breaking the components because of the force being hard to be applied to the portions excluding the adhered portions of the components than such a case that the components adhesively bonded by the adhesive member are held and then pulled apart from each other.

Further, the component adhesive bonding structure 1 is configured so that upon heating the thermo-expandable material 3, the adhesive member 2 is pushed in the direction of getting apart from the first component 4 and thus exfoliated. Hence, the component adhesive bonding structure reduces the adhesive member 2 remaining on the first component 4 to a greater degree than the case of holding and thus pulling the components apart from each other.

Note that the thermo-expandable material 3 is sufficient if disposed between the adhesive member 2 and at least one of the components adhesively bonded by the adhesive member 2 and may be disposed in, e.g., the recessed portion formed in one portion of the adhesive surface of the adhesive member 2 and may also be disposed between the second component 5 and the adhesive member 2. The thermo-expandable materials 3 are disposed, e.g., both between the first component 4 and the adhesive member 2 and between the second component 5 and the adhesive member 2, in which case the residuals of the adhesive members 2 on both of the first component 4 and the second component 5 can be reduced to the greater degree than the case of holding and thus pulling the components apart from each other.

Further, the recessed portion 6 may be designed in a way that accords with, e.g., an area, the adhesive force, etc of the adhesive surface of the adhesive member 2. Namely, a size of the recessed portion 6 may be set to a size enabling the adhesive area to be ensured, which is required for adhering, e.g., the second component 5 to the first component 4. Moreover, an internal size of the recessed portion 6 may be set to a size enabling the recessed portion 6 to be filled with such a quantity of thermo-expandable material 3 that the thermo-expandable material 3 being thermally expanded can get the adhesive member 2 exfoliated from the first component 4. Furthermore, the recessed portion 6 may be formed with an aperture portion broader than a bottom portion so that, e.g., the thermo-expandable material 3 gets the first component 4 and the second component 5 to be easily pushed apart from each other.

Further, the thermo-expandable material 3 may be a material that starts thermally expanding at a temperature higher than, e.g., a usage temperature and a storage temperature of the first component 4 and the second component 5. Still further, the thermo-expandable material 3 may also be a material that, e.g., when heated, expands in volume to an extent enabling the first component 4 and the second component 5 to be sufficiently pushed apart from each other. Yet further, the adhesive member 2 may also be a member that maintains its own morphologic integration to facilitate the exfoliation from the first component 4 upon being pushed by, e.g., the thermo-expandable material 3.

The component adhesive bonding structure 1 can be modified as follows. A description of a modified example given below will be focused on portions different from the component adhesive bonding structure 1 according to the embodiment, and explanations of other portions are omitted in the way of marking these portions with the same reference numerals and symbols.

### Modified Example of Embodiment

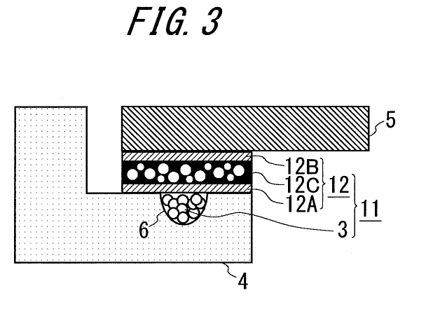

FIG. 3 depicts a component adhesive bonding structure 11 according to the modified example of the embodiment. The component adhesive bonding structure 11 according to the present modified example includes an adhesive member 12 and the thermo-expandable material 3. The adhesive member 12 includes a first adhesive agent 12A, a second adhesive agent 12B and a tape- or sheet-shaped substrate 12C. The first adhesive agent 12A may have the same constituents as the second adhesive agent 12B has and may also have different constituents. A shape of the substrate 12C is variable by dint of an expansion force of the thermo-expandable material 3.

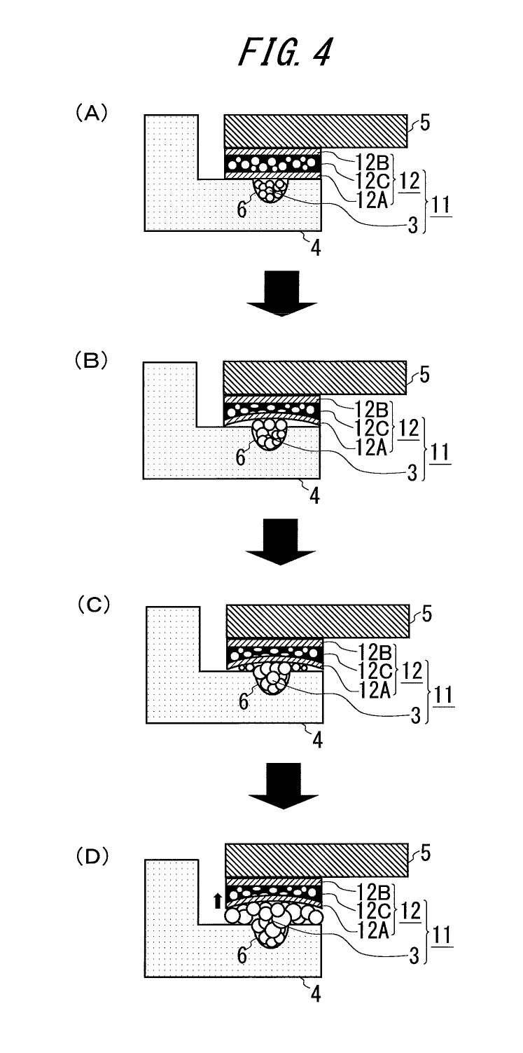

The first component 4 and the second component 5, which are adhesively bonded together by the component adhesive bonding structure 11, can be separated in the way described below. FIG. 4 depicts one example of a component separation method according to the present modified example.

The adhesive member 12, if the pushing force of the thermo-expandable material 3 expanding upon being heated exceeds the adhesive force of the first adhesive agent 12A, starts being peeled off from the first component 4 with its starting point being the portion where the thermo-expandable material 3 is disposed (see FIG. 4(B)). The adhesive member 12, when starting being peeled off from the first component 4, receives the pushing force of the thermo-expandable material 3 that expands upon being heated, whereby the substrate 12C begins being pushed. With the advancement of the expansion of the thermo-expandable material 3 that swells out while pushing the substrate 12C and expanding a space between the first component 4 and the first adhesive agent 12A of the adhesive member 12, the adhesive member 12 is further peeled off from the first component 4 (see FIG. 4(C)). The adhesive member 12 is, when the expansion of the thermo-expandable material 3 further advances, exfoliated from the first component 4.

The second component 5 is, when the adhesive member 12 is exfoliated from the first component 4, pushed apart from the first component 4 by dint of the pushing force of the thermo-expandable material 3 (see FIG. 4(D)).

In the component adhesive bonding structure 11, the adhesive member 12 includes the substrate 12C, and hence the thermo-expandable material 3 can expand while pushing the substrate 12C and expanding the space between the first component 4 and the first adhesive agent 12A of the adhesive member 12. The adhesive member 12 is therefore easier to exfoliate from the first component 4 than the adhesive member 2 according to the embodiment.

Moreover, the shape of the substrate 12C, if being, e.g., a sponge-like foaming body, is easily variable by dint of the expansion force of the thermo-expandable material 3. Still moreover, the shape of the substrate 12C, if being, e.g., a waterproof foaming body using polyethylene and acryl, is easily variable by dint of the expansion force of the thermo-expandable material 3 while giving high waterproofness to the adhesively-bonded portions.

### Applied Examples of Embodiment and Modified Example

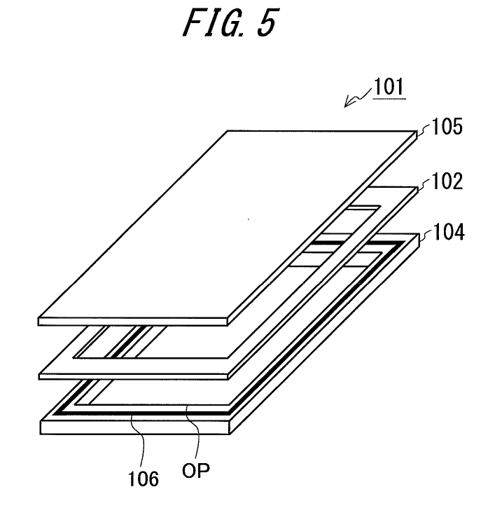

FIG. 5 illustrates an electronic component 101 by way of an applied example of the embodiment or the modified example. Note that the present applied example exemplifies a case of applying the component adhesive bonding structure according to the modified example to the electronic component 101 but is the same with respect to a case of applying the component adhesive bonding structure 1 according to the embodiment to the electronic component 101.

The electronic component 101 is, e.g., mobile equipment, and includes a resin casing 104 and an LCD (Liquid Crystal Display) panel 105. The casing 104 has an opening OP. The panel 105 is adhesively bonded to the casing 104 via a double-sided adhesive tape 102 so as to seal the opening OP of the casing 104.

The present applied example exemplifies the case of applying the component adhesive bonding structure 11 according to the modified example to the adhesive bonding between the casing 104 and the panel 105, and it therefore follows that the casing 104 corresponds to the first component 4, the panel 105 corresponds to the second component 5, and the double-sided adhesive tape 102 corresponds to the adhesive member 12.

The casing 104 is formed with a groove taking a recessed shape in section (which will hereinafter be referred to as a recessed groove 106) along the edge of the opening OP. The recessed groove 106 corresponds to the recessed portion 6 and is formed narrower than a lateral width of the double-sided adhesive tape 102 via which to adhesively bond the casing 104 and the panel 3 together. The recessed groove 106 is filled with the thermo-expandable material 3.

Note that the recessed groove 106 may be designed corresponding to, e.g., the width, the adhesive force, etc of the double-sided adhesive tape 102. That is, the width of the recessed groove 106 maybe set to a width that enables ensuring an adhesion area required for adhering the panel 105 to the casing 104. Further, a size of an interior of the recessed groove 106 may be set to, e.g., a size that enables the recessed groove 106 to be filled with such a quantity of thermo-expandable material 3 that the thermo-expandable material 3 being thermally expanded can exfoliate the double-sided adhesive tape 102 from the casing 104.

On the occasion of separating the panel 105, the thermo-expandable material 3 is indirectly heated by heating the adhesively bonded portion of the double-sided adhesive tape 102. When a temperature of the thermo-expandable material 3 rises, the thermo-expandable material 3 expands, and there is generated a force of pushing the double-sided adhesive tape 102 in a direction of getting apart from the casing 104, thereby pushing the panel 105 apart from the casing 104. Hence, the panel 105 assembled by use of the double-sided adhesive tape 102 can be easily removed from the casing 104.

For example, the assembly of the mobile equipment such as a mobile phone involves often using the adhesive tape in order to facilitate the assembly and reduce costs. The adhesively bonded portion is requested to have mutually contradictory characteristics such as the rigid adhesiveness durable against the use and the facilitation to remove the component as in the case of replacing a defective component. It is actually, however, difficult to manufacture the adhesive tape compatible with these two characteristics.

This being the case, such a method is considered that the components are pulled apart from each other in the way of decreasing the adhesive force by dissolving the adhesive member with a solvent. The method using the solvent has, however, a possibility of breaking the components themselves and requires consideration in terms of safety such as conducting ventilation and wearing a protector.

If being the component adhesive bonding structures 1, 11, however, the possibility is low that the components are to be breaked when separating from each other the components which are adhesively bonded by the adhesive members 2, 12, and hence spoilage expenses can be reduced by combining the separated components with other components.

Further, if being the component adhesive bonding structures 1, 11, the adhesive members 2, 12 remaining on the components are decreased, and the components are therefore easy to be reused.

Note that the recessed groove 106 can be properly disposed corresponding to a shape and an area of the double-sided adhesive tape 102 via which the casing 104 and the panel 105 are adhesively bonded together.

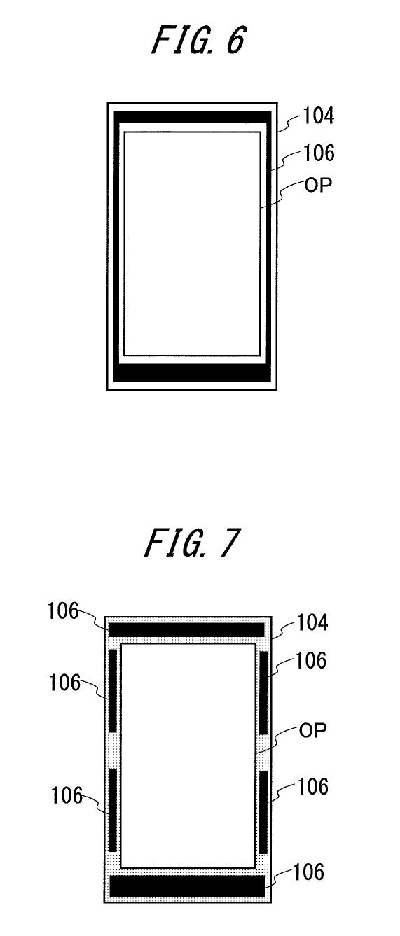

That is, the recessed groove 106 may be disposed, for instance, as depicted in FIG. 6, in a whole circumference along the edge of the opening OP. If the recessed groove 106 is disposed in the whole circumference and when the thermo-expandable material 3 expands, the double-sided adhesive tape 102 via which to adhesively bond the casing 104 and the panel 105 together is exfoliated over the whole circumference.

Moreover, the recessed groove 106 may be, e.g., as illustrated in FIG. 7, disposed in a part of the edge of the opening OP. For example, the recessed groove 106 is omitted in the portions where the double-sided adhesive tape 102 can be easily peeled off, whereby the adhesively bonding strength and an exfoliative property of the double-sided adhesive tape 102 can be adjusted. Moreover, a filling quantity of the thermo-expandable material 3 can be reduced.

### Supplementary Items Pertaining to Embodiment, Modified Example and Applied Example

Note that the adhesive agent of each of the adhesive members 2, 12 is a gel substance having, e.g., a high viscosity and may also be what decreases in viscosity under a temperature higher than a normal temperature though tightly adhered to the component under the normal temperature and thus decreases in adhesion to the component. If being the adhesive member such as this, the adhesive members 2, 12 become easier to be peeled off from the components as the temperature of the thermo-expandable material 3 becomes higher.

Further, in the component adhesive bonding structure 11, the substrate 12C may involve using, e.g., a sponge-like sheet containing the foam at a volume ratio of about 40%-70%. The substrate, if composed such as this, has sufficient flexibility in a thicknesswise direction and is kept in terms of strength for maintaining the morphologic integration, and therefore the thermo-expandable material 3 is easy to expand, with the result that the adhesive member 12 is easy to be peeled off from the component.

Moreover, the thermo-expandable material 3 may be what swells, e.g., several ten to several hundred times in volume when heated. The thermo-expandable material is, if having a characteristic such as this, capable of sufficiently pushing the first component 4 and the second component 5 apart from each other when expanding. This type of material can be exemplified by what a thermoplastic shell contains a liquid that evaporates upon being heated. When there occurs a phase change from the liquid to a gas, generally the volume thereof swells several ten to several hundred times. Hence, if the liquid is evaporated by heating what the thermoplastic shell contains the liquid, the evaporated gas can swell the thermoplastic shell without leaking out of the adhered portions.

### Working Example

The following are results of performing experiments of the component adhesive bonding structure 11 by use of materials available on the market. The experiment demonstrated as below involves using a “Waterproof Double-Sided Adhesive Tape (DAITAC (registered trademark) WS#8402 Series) for the mobile equipment, which is made by DIC Corporation, byway of one example of the adhesive member 12. The waterproof double-sided adhesive tape for the mobile equipment, which is used in the present experiment, is 60-130 N/cm² in average of the adhesive strength.

Further, the experiment demonstrated as below involves using a thermo-expandable microcapsule (“Matsumoto Micro Sphere” (registered trademark) F-, FN-Series), which is made by Matsumoto Yushi Seiyaku Co., Ltd., by way of one example of the thermo-expandable material 3. The thermo-expandable microcapsule used in the present experiment is a spherical capsule that is 10-20 μm in average particle size and swells 50-100-fold in volume when heated. Moreover, a foaming start temperature is 70-100° C. higher than a storage temperature of the mobile phone.

The component adhesive bonding structure 11 is configured by using the materials such as these, and the thermo-expandable microcapsule is heated, at which time it is confirmed that the thermo-expandable microcapsule expands with the result that the adhesive member 12 is exfoliated from the first component 4.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A component adhesive bonding structure comprising:
an adhesive member to adhesively bond components together; and
a thermo-expandable material to expand upon being heated in the way of being disposed between at least one of the components being adhesively bonded together by the adhesive member and the adhesive member.

2. The component adhesive bonding structure according to claim 1, wherein the thermo-expandable material is disposed at a part of an adhesive surface.

3. The component adhesive bonding structure according to claim 1, wherein the adhesive member includes a tape- or sheet-like substrate of which a shape becomes variable by dint of an expansion force of the thermo-expandable material.

4. The component adhesive bonding structure according to claim 1, wherein the thermo-expandable material is put into a recessed portion formed in any one of the components as well as at the part of the adhesive surface.

5. A component separation method comprising:
heating and thus expanding a thermo-expandable material being disposed between at least one of components being adhesively bonded by an adhesive member via which to adhesively bond the components together and the adhesive member; and
pushing the adhesive member in such a direction as to get apart from at least one of the components.
